(19) United States
(12) Patent Application Publication
(10) Pub. No.: US 2003/0125072 A1
(43) Pub. Date: Jul. 3, 2003

(54) Method of providing multiple mobile telephones with the same telephone number

(76) Inventor: Paul W. Dent, Pittsboro, NC (US)

Correspondence Address: COATS & BENNETT, PLLC, P O BOX 5, RALEIGH, NC, 27602, US

(21) Appl. No.: 10/037,497

(22) Filed: Jan. 2, 2002

(51) Int. Cl. H04Q 7/20

(52) U.S. Cl. 455/551; 455/445; 455/518; 455/458; 455/567

(57) ABSTRACT

Multi-extension functionality is provided to a group of two or more mobile terminals in a wireless communication network by the provision of a common number associated with the group. The common number and identification of all mobile terminals in the group are stored in a subscriber database. When a call directed to the common number is received, the caller may be prompted to select an option for contacting group members, such as calling a specific group member, the first to answer, or all group members. Mobile terminals in the group are paged accordingly via their individual telephone numbers, and the appropriate call connections established. The call placement action may be predetermined, selected by the caller, or dependent on extrinsic data. Calls placed by group members may have the common number reported in caller-ID in lieu of their individual telephone numbers.

### BACKGROUND OF THE INVENTION

The present invention relates generally to the field of wireless communication networks, and specifically to a method of providing multiple mobile terminals with the same telephone number.

Fixed (landline) telephone subscribers are accustomed to having multiple phones installed in their homes so that they do not have to rush from one room to another when the phone rings. All phones may be on the same line and associated with the same local telephone exchange number, so that all ring when the single number is called.

Mobile wireless communication network operators typically do not allow two mobile terminals to exist with the same number. The reason for this is twofold. First, the mobile phone industry has in the past been plagued by fraud in which a mobile terminal is “cloned” using a genuine subscriber's mobile terminal identity, the clone then being used to place illicit calls. Such fraud can be detected by detecting the use of the same mobile phone number in two different places at once.

Another reason for disallowing two mobile terminals with the same number is the need to keep track of the location of a mobile terminal. A mobile terminal's current location must be known to the network in order to know which base station to use to transmit call alerts to the mobile terminal. It is not possible to page every mobile terminal nationwide, as the paging capacity is insufficient. Therefore it is necessary to restrict paging of a mobile terminal to a paging area comprising the last known base station with which the mobile phone had contact, and the surrounding base stations. Since the mobile terminal's phone number is the means to discriminate between different mobile terminals, prior art systems cannot have more than one location associated with a single mobile phone number.

Thus, it has not been possible within existing wireless communication networks to provide mobile terminal subscribers with the same convenience as fixed telephone subscribers, of having multiple phones with the same number.

### SUMMARY OF THE INVENTION

The present invention includes a method of providing multi-extension functionality to a group of mobile terminals in a wireless communication network. The method comprises receiving a call at a switching center directed to a common number shared by two or more mobile terminals, and connecting the call to at least one of said mobile terminals. Connecting the call includes selecting one or more mobile terminals sharing said common number; and connecting said call to the selected mobile terminals. The caller may be prompted to select at least one mobile terminal sharing said common number, the caller's selection received, and the call connected to the selected mobile terminal. If the caller selects two or more mobile terminals, a group call may be established.

In one embodiment, the method includes maintaining a subscriber database accessible to the communication network switching center for storing a common number shared by two or more mobile terminals, and accessing the subscriber database to identify the mobile terminals.

In another embodiment, the present invention includes a method of placing a call from any of a group of mobile terminals, in a wireless communication network capable of reporting the telephone number of the originating mobile terminal. The method comprises assigning a common number to a group of two or more mobile terminals, each mobile terminal associated with a telephone number, storing the common number in a subscriber database; storing the mobile terminal telephone numbers in the subscriber database, associating the common number with each telephone number, and when a mobile terminal in the group originates a call, reporting the common number in lieu of the telephone number associated with the mobile terminal. The method may include blocking the reporting of the telephone number of the originating mobile terminal if the communication network is incapable of reporting the common number. The actual number may be reported if the called number is included in a list of trusted numbers, or if the called number is the common number.

### BRIEF DESCRIPTION OF DRAWINGS

FIG. 1 is a functional block diagram of a wireless communication network;

FIG. 2 is a functional block diagram of a subscriber database; and

FIG. 3 is a flowchart depicting a call handling procedure according to one embodiment of the present invention.

### DETAILED DESCRIPTION OF THE INVENTION

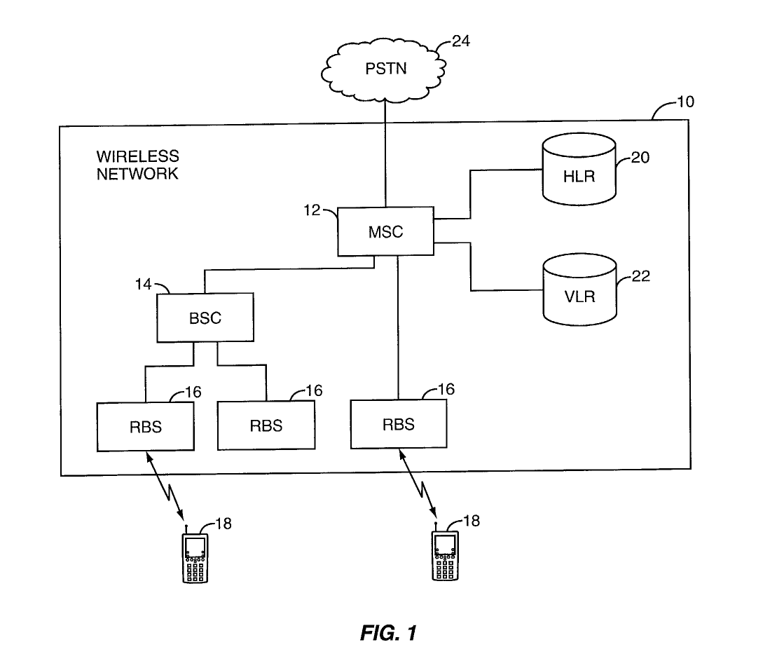

A geographically limited portion of a typical wireless communication network 10 is depicted in FIG. 1. The network 10 contains a Mobile Switching Center (MSC) 12, a Base Station Controller (BSC) 14, a plurality of Radio Base Stations (RBSs) 16, a Home Location Register (HLR) 20, and a Visitor Location Register (VLR) 22. Note that the network 10 may include multiple instances of some or all of these elements in portions covering different geographic areas. RBSs 16 establish and maintain wireless voice and data communications links with mobile terminals 18, such as via radio frequency transmissions. Each RBS 16 provides wireless communication to mobile terminals 18 within its geographic coverage region, or cell. One or more RBSs 16 may be controlled by a BSC 14, which routes communications between the RBSs 16, or between an RBS 16 and an MSC 12. Alternatively, one or more RBSs 16 may be controlled directly by the MSC 12.

The MSC 12 is operative to connect calls between RBSs 16; between a RBS 16 and a RBS 16 connected to a different MSC 12 (not shown); or between a RBS 16 and another communication network, such as the Public Switched Telephone Network (PSTN) 24. The MSC 12 additionally controls the operation of mobile terminals 18 within the coverage regions or cells of RBSs 16 under its control. The MSC 12 selects one of a number of free communications channels, such as indicated by the BSC 14 to be available at the site, to be used by a mobile terminal 18 for call traffic, which may comprise speech or data. Alternatively, channel selection may by performed by the BSC 14. The selected communications channel may be a frequency, a timeslot, a CDMA code, a frequency hopping pattern or any combination of these, depending on the radio air-interface standard in use. The parameters of the selected traffic channel are sent to the mobile terminal 18 in a channel assignment message that is transmitted on the calling channel or on a temporary channel, which can both be referred to as a “call set-up channel.” The mobile terminal 18 then leaves the call set-up channel and commences transmitting and receiving on the assigned traffic channel.

The MSC 12 is connected to a HLR 20, a database containing information associated with subscribers within the coverage area of MSC 12. Additionally, MSC 12 is connected to a VLR 22, a database used to store user information associated with visiting or “roaming” subscribers.

The HLR 20 is used to store information concerning subscribers to the wireless communication network 10. This information typically includes the user's name and address for billing purposes, the serial number of the user's mobile terminal 18, and the services that the user is entitled to receive or access. In addition, the current location of the subscriber is stored in the HLR 20 for retrieval by an MSC 12 to use in routing calls to the subscriber. The mobile terminal 18 registers with the servicing MSC 12 when it is powered on and at periodic intervals so that the servicing MSC 12 can keep track of the location of the mobile terminal 18. The mobile terminal 18 also registers when it travels between two different service areas (areas served by different MSCs 12). As part of this registration procedure, the mobile terminal 18 transmits a unique identification number, such as for example a Mobile Identification Number (MIN) or International Mobile Subscriber Identity (IMSI), to the MSC 12. The MSC 12 uses the MIN/IMSI to determine which HLR 20 to access. When the mobile terminal 18 registers with MSC 12, the serving MSC 12 updates the HLR 20 with the current location of the mobile terminal 18. When an MSC 12 receives a call addressed to a subscriber that is not currently in that MSC's 12 service area, the MSC 12 will query the HLR 20 for the subscriber's location so that the call can be forwarded to the MSC 12 currently servicing the subscriber.

The VLR 22 is used to store information about users that are not in their home service area. When subscribers roam outside of their home service area, the VLR 22 in the area being visited must keep track of the subscriber's location and be able to verify the MIN/IMSI of the mobile terminal 18. The VLR 22 in the area being visited queries the HLR 12 in the subscriber's home service area to authenticate the subscriber and determine the services to which the subscriber is entitled. Information concerning the user is stored in the VLR 22 as long as the subscriber remains in the service area. The VLR 22 also stores the current location of the subscriber. The subscriber's current location is also communicated back to the home HLR 12 so that the home network will know how to forward calls addressed to the subscriber who is currently outside of the home network.

As an example of the use of the HLR 20 and VLR 22 as part of the Mobility Management System of wireless communication network 10, the process of updating a mobile terminal's 18 location, and routing calls to it, may comprise the following steps:

1. The wireless communication network 10 broadcasts the paging area ID of the paging area to which a RBS 16 belongs to all idle mobile terminals 18 in that paging area;

2. An idle mobile terminal 18 detects when the strongest received RBS 16 is broadcasting a paging area ID different than the paging area in which the mobile terminal 18 last registered. The mobile terminal 18 transmits a re-registration or “location update” message to the wireless communication network 10;

3. A HLR 20 associated with the subscriber's home MSC 12 stores the ID of a paging area or VLR 22 with which each mobile terminal 18 last registered;

4. An MSC 12 receives calls for its native subscribers, accesses its HLR 20 to retrieve their current VLR 22 ID, then reroutes the calls to the MSC 12 hosting the retrieved VLR 22 for connection to the mobile terminal 18.

The MSC 100 is generally a special purpose computer having redundant hardware for operational reliability, and is controlled by a stored program. The Ericsson AXE switch is an example of such a stored-program controlled telephone switching computer. Software is partitioned into modules that may be linked into an Operating System according to customer requirements. Software modules may belong to any one of a number of software subsystems that reside on an MSC 12. Examples of software subsystems are the Mobility Management subsystem, which manipulates the subscriber-related data stored in the HLRs 20 and VLRs 22, and the Billing System, which tracks call minutes used by each subscriber and combines them with multiple rate schedules according to the type of subscription for each subscriber, the nature of the call (long distance or local, native subscriber or roaming subscriber), and other factors. Other software modules for call handling can include implementing features such as Call Forwarding, Voice Mail, Caller ID, Caller ID blocking and Short Message Service (SMS). In one embodiment, the present invention may be implemented by provision of an appropriate software module for the MSC 12.

According to the present invention, a group of mobile terminals 18 in a wireless communication network 10 may operate with much of the multi-extension functionality associated with traditional wire-line telephone systems through the provision of a common number. The common number is a subscriber phone number associated with a group of two or more mobile terminals 18. When a call is placed to the common number, all or some subset of the group of mobile terminals 18 associated with the common number rings. One or more of the mobile terminals 18 that answer are connected with the caller. The mobile terminal(s) 18 connected to the call may be selected in a variety of ways. The first mobile terminal 18 of the group to answer may be connected. The MSC 12 may then cease ringing the remaining mobile terminals 18 in the group, or alternatively may continue ringing them. In the latter case, other mobile terminals 18 within the group that answer may be connected to the call, creating a group call, or a communication session comprising three or more parties. Alternatively, the MSC may prompt the party placing the call to select which one of the mobile terminals 18 to ring, for example by playing a recorded message such as:

“For Mrs Subscriberman, press 1”

“For Mr. Subscriberman, press 2”

“For both Mr and Mrs Subscriberman, press 3”

“or hold for first available”

As another alternative, these selections may be predetermined for specific common numbers, or may be made by the MSC 12 based on a variety of conditions or factors.

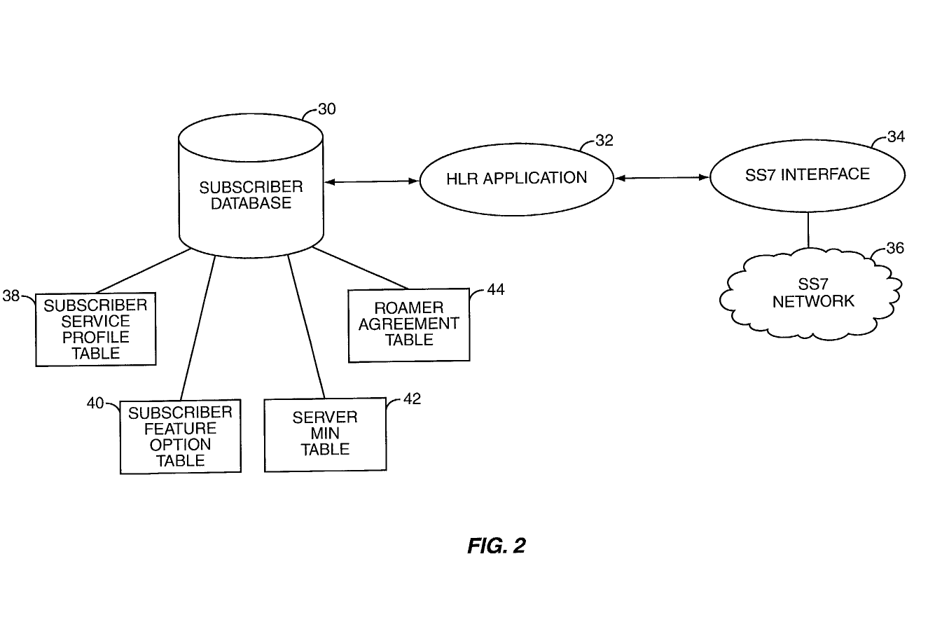

A functional block diagram of an exemplary embodiment of the subscriber database according to the present invention is depicted in FIG. 2. The subscriber database 30 is controlled by a HLR application 32, which in turn is connected through a signaling interface 34 to a network 36. The subscriber database 30, which, in a given implementation, may comprise the HLR 20, stores and updates such subscriber information as current subscriber location and activity status, subscriber identification information, subscription information such as features and privileges, service restrictions, subscriber feature information such as forward-to numbers, data enabling calls to be delivered to subscribers, and the like. The HLR application 32 is a software control application that accesses and updates the subscriber database 30. The HLR application 32 may control such features as subscriber validation, signaling network access, subscriber roaming, subscriber access and traffic analysis, security and fraud protection, and the like. The network interface 34 connecting the HLR application 32 with the network 36 may implement the SS7 network signaling protocols defined by ANSI and incorporated herein by reference. Similarly, the network 36 may comprise an SS7 network, which may for example be the wireless communication network 10 of FIG. 1.

As shown in FIG. 2, the subscriber database 30 includes several database tables, including a subscriber service profile table 38, a subscriber feature option table 40, a served MIN table 42, and a roamer agreement table 44, all of which are well known in the art and need not be explicated herein. In one embodiment, the present invention may be implemented by modification to the subscriber service profile table 38. The subscriber service profile table 38 contains the records established for each subscriber served by MSC 12. The table 38 includes identification data, such as the MIN/IMSI and subscriber telephone number; call profile data, such as credit status, call origination indicator, call termination restriction, and preferred interexchange carrier; qualification data, such as authorization period, call history count, and carrier-requested or subscriber-requested disconnect; feature activation information for each feature available and feature information, such as a forward-to number for call forwarding; location and activity status, such as VLR identification information and registration status, and fraud protection information.

According to the present invention, the subscriber telephone number in the subscriber service profile table 38 may be a common number associated with a group of two or more mobile terminals 18. This may be indicated by a Group Code, which may also identify the group. Mobile terminals 18 that are members of a group are so indicated by a unique group code, that is distinct from a default group code. A default group code (for example, all zero's) indicates that the associated mobile terminal 18 is not a member of a group, and consequently the associated subscriber telephone number is an individual telephone number.

In addition to indicating group membership, the group code identifies a subscriber telephone number as the common number for a group. In one embodiment, this indication comprises a binary flag in one bit position of the group code bit field. For example, the group code may comprise a nine-bit field, with one bit being designated as a common number flag. Thus, an eight-bit field indicates the group identification code (yielding 2⁸-1 or 255 unique groups). One of skill in the art will readily recognize that the size of the group code bit field may be altered to accommodate any number of groups, as necessary or desired.

Table 1 below depicts representative entries in the subscriber service profile table 38, with comments explaining their significance.

TBLE 1
Representative Subscriber Service Profile Table Entries

| Subscriber | Group Code | | |
|---|---|---|---|
| Telephone | | CN | |
| Number | Group ID | Flag | Comments |
| 555-3925 | 0000 0000 | 0 | Individual mobile terminal, not a member of any group. |
| 555-6992 | 0000 0011 | 0 | Individual mobile terminal, member of group 3. |
| 555-1104 | 0010 0110 | 0 | Individual mobile terminal, member of group 38. |
| 555-4995 | 0000 0011 | 1 | Common number for group 3. |
| 555-0038 | 0000 0011 | 0 | Individual mobile terminal, member of group 3. |
| 555-3766 | 0010 0110 | 1 | Common number for group 38. |
| 555-2020 | 0000 0000 | 0 | Individual mobile terminal, not a member of any group. |

As an example of the use of the subscriber service profile table 38 to route a call directed to a common number, assume that MSC 12 receives a call request directed to 555-4995. MSC 12 scans the subscriber service profile table 38, and retrieves the associated group code 0000 0011 and common number flag of 1, indicating that the number is the common number for group 3. The MSC 12 may then scan the Group ID sub-field of the subscriber service profile table 38 to locate all mobile terminals 18 that are members of group 3—in this example, those associated with the telephone numbers 555-6992 and 555-0038. The MSC 12 may proceed to provide multi-extension functionality to these mobile terminals 18, as described below.

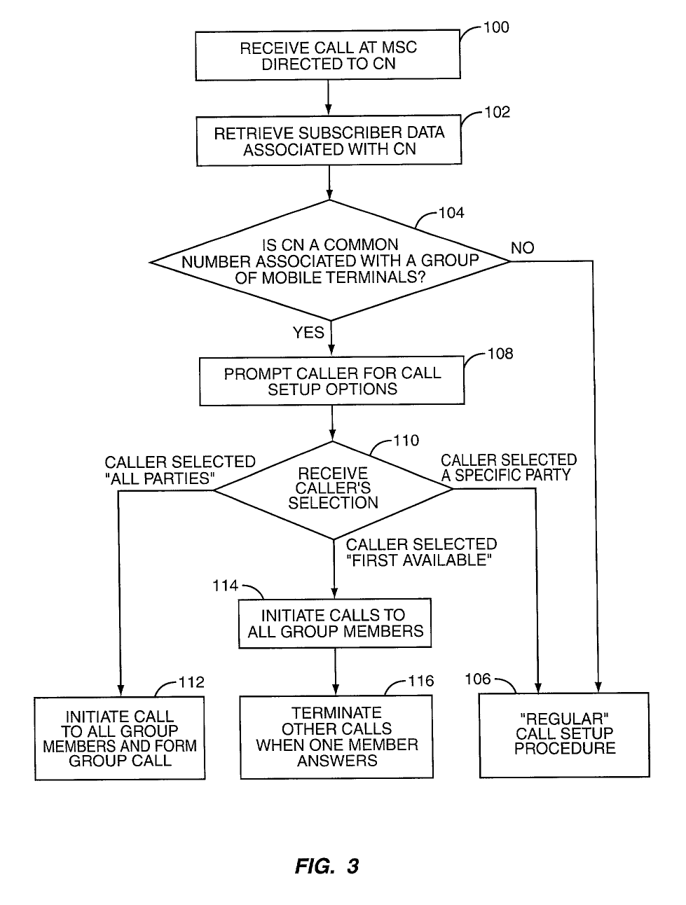

An exemplary embodiment of the present invention, demonstrating the handling of an incoming call, is depicted as a flowchart in FIG. 3. Initially, a call is received at the MSC12 for one of its native subscribers with the called phone number CN (block 100). The MSC 12 retrieves the data or profile associated with the subscriber having phone number CN from the MSC's 12 subscriber database, which may reside in memory in the MSC 12, or may be implemented as part of the HLR 20 (block 102). The subscriber data is analyzed to determine if the called number CN is a common number associated with a group of mobile phones 18 (block 104). If not, i.e., if CN represents a single mobile terminal, the MSC 12 performs a regular call setup procedure for calling the mobile terminal 18 with number CN (block 106) as is known in the art. This process may include retrieving from the HLR 20 the current location of the mobile terminal 18 associated with number CN, which may be a location served by a RBS 16 controlled by the MSC 12 itself if the subscriber is in his local area, or alternatively may be a location defined by a VLR 22 connected to a different MSC 12, if the subscriber has roamed outside his local area. In the latter case, the call is redirected to the other MSC 12 for completion.

If the retrieved subscriber profile associated with the called number CN (step 104) indicates that the called phone number is a common number associated with a group of mobile terminals 18, then the caller may be prompted to specify whether he wishes to select a particular party, the first available party, or all parties (block 108). Depending on the selection received from the caller (block 110), control passes to block 106, block 114, or block 112, respectively. If a specific group member is selected by the caller, a regular call setup to a single, specific mobile terminal 18 is performed, using the actual mobile terminal 18 telephone number retrieved from the subscriber profile (block 106). If “first available” is selected at block 110, calls are placed to all group members, i.e., to all the actual telephone numbers retrieved from the subscriber profile (step 114). This is conceptually a multiple instance of the regular call setup procedure at block 106 as described above, which may include determining the current locations of all the mobile terminals 18 called, using HLR 20 and/or VLR 22. However, upon any group member answering, the calls to the remaining mobile terminals 18 of the group are terminated (block 116). In other words, once a call connection is established, all pending calls to other group members are dropped. Finally, if “all parties” is selected at block 110, calls are placed to all the mobile terminals 18 in the group as indicated by the subscriber profile, and a group call is established by connecting each group member as each they answer (block 112). Note that the call setups to all group members at block 112 may additionally be considered a multiple instance of the regular call setup procedure at block 106, and may involve locating and routing calls to group member mobile terminals 18 across the network 10. In the particular case that “all parties” is selected at block 110 and the caller is a member of the group associated with the common number, the MSC 12 may detect this fact and exclude the calling mobile terminal 18 from the conference call setup procedure at step 112. Other options may be implemented as necessary or desired, such as automatically excluding a member of the group from the conference call if his mobile terminal 18 is busy, or automatically including a member whose mobile terminal 18 was busy at the call setup, when his previous call terminates, if the conference is still ongoing. Such modifications may be made by one skilled in the art, and are within the scope of the present invention.

Block 108 in the flowchart of FIG. 3 is optional and exemplary, and may include a greater or smaller number of options presented to the caller. Alternatively, it may be omitted altogether. For example, the subscriber profile data may indicate that the caller is not to be prompted to specify options, and a default action will be listed in the subscriber profile. In this case, the response of MSC 12 to the called number CN is dependent upon the number itself. For example, all incoming calls to one common number may result in all associated mobile terminals 18 being joined in a conference call. This may be appropriate for a group requiring unanimous consent or the notification of all group members. On the other hand, incoming calls directed to another common number may always result in a “first available” connection, as may be appropriate for a group of repair or emergency personnel, the response or alerting of any one of whom is sufficient for the calling party. Extrinsic, dynamic data may also be considered in deciding the appropriate call setup action. For example, calls to a particular common number may be directed to one or more members of the associated group of mobile terminals 18 in response to the date or time of day at which the call is received, as may be advantageous to accommodate shifts or other work schedules.

For geographically restricted communications, or to contain costs, subscriber profile data associated with a common number may specify that only those mobile terminals within the service area of MSC 12, or a subset thereof, be called in response to a call placed to the common number, i.e., the procedures described with respect to block 106 of FIG. 3 may be limited to the originating MSC 12 and HLR 20. In general, the response of MSC 12 to an incoming call directed to a common number may assume a wide variety of variations and permutations, based on a wide array of factors, and still fall within the scope of the present invention, which is not limited to any particular embodiment disclosed or illustrated herein.

As will be readily apparent to one of skill in the art, according to the present invention any mobile terminal 18 may be a member of more than one group, and thus may respond to more than one common number. Conversely, there is no inherent limit on the size of any group of mobile terminals 18 that may be associated with a common number.

Another feature of the present invention is that, unlike a multi-extension landline telephone, multiple simultaneous calls may be placed to a common number, resulting in multiple simultaneous conversations. For example, if a common number is associated with a family, and a caller selects one particular family member at block 110, the caller will be connected to that family member's mobile terminal 18 at block 106. Simultaneously, or subsequently, another caller may call the common number and be connected to a different family member by selecting the “first available” option. Thus, according to the present invention, a group such as a family may realize the benefits of a single telephone number (such as unified billing, a single listing, and the like), and additionally enjoy the benefits of the underlying point-to-point connections that utilize different individual telephone numbers.

According to one embodiment of the present invention, if one of the mobile terminals 18 belonging to the group associated with a common number initiates a call, the common number may be reported (if the MSC 12 supports and implements an originating number reporting feature, such as caller-ID) in lieu of the mobile terminal's 18 unique telephone number. Such substitution may be dependent upon data in the subscriber profile associated with the common number and/or with the mobile terminal 18, or may be received from the user upon placing the call. Thus, either the common number or the mobile terminal's 18 unique telephone number may be reported, as selected by the subscriber's default choice and/or as dynamically selected at the time the call is placed. As in the case of call setup options for incoming calls, as described above, the MSC 12 may easily incorporate additional extrinsic data into the decision, such as time, date, location of the mobile terminal 18, or the like, as desired. Since the substitution of the common number for a the mobile terminal's 18 unique telephone number may involve inter-MSC signaling of the common number which may not be implemented at other MSCs 12, caller-ID release may be blocked if the common number cannot be displayed.

The substitution of the common number may be dependent on the number called. For example, if the subscriber has informed one or more parties privately of the unpublished actual mobile terminal's 18 unique telephone number, the MSC 12 may be programmed to place calls directly to those parties' specific numbers without substituting the common number, which for example could be the means by which members of the group contact each other.

As used herein, the term “mobile terminal” may include a cellular radiotelephone with or without a multi-line display; a Personal Communications System (PCS) terminal that may combine a cellular radiotelephone with data processing, facsimile and data communications capabilities; a Personal Digital Assistant (PDA) that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A method of providing multi-extension functionality to a group of mobile terminals in a wireless communication network, comprising:
receiving a call at a switching center directed to a common number shared by two or more mobile terminals, and
connecting said call to at least one of said mobile terminals.

2. The method of claim 1 wherein connecting said call to at least one of said mobile terminals comprises:
selecting one or more mobile terminals sharing said common number; and
connecting said call to said selected mobile terminals.

3. The method of claim 2 wherein selecting one or more mobile terminals sharing said common number comprises:
prompting a caller to select at least one mobile terminal sharing said common number;
receiving the caller's selection; and
connecting said call to the mobile terminal selected by the caller.

4. The method of claim 4 further comprising establishing a group call if the caller selects two or more mobile terminals.

5. The method of claim 1 wherein connecting said call to at least one of said mobile terminals comprises establishing a group call involving two or more mobile terminals.

6. The method of claim 1 further comprising:
maintaining a subscriber database accessible to said switching center for storing said common number shared by two or more mobile terminals, wherein said switching center accesses said subscriber database to identify said mobile terminals.

7. A method of providing multi-extension functionality to a group of mobile terminals in a wireless communication network, comprising:
receiving a call at a switching center directed to a called number; and
determining whether the called number is a common number shared by two or more mobile terminals.

8. The method of claim 7 further comprising storing subscriber phone numbers in a subscriber database, said database further including data indicating whether a subscriber phone number is a common number, and using said subscriber database to determine whether the called number is a common number shared by two or more mobile terminals.

9. The method of claim 7 further comprising, if said called number is a common number, connecting said call to at least one mobile terminal sharing said common number.

10. The method of claim 9 wherein connecting said call to at least one mobile terminal sharing said common number comprises:
selecting one or more mobile terminals sharing said common number; and
connecting said call to said selected mobile terminals.

11. The method of claim 10 wherein selecting one or more mobile terminals sharing said common number comprises:
prompting a caller to select at least one mobile terminal sharing said common number;
receiving the caller's selection; and
connecting said call to the mobile terminal selected by the caller.

12. The method of claim 11 further comprising establishing a group call if the caller selects two or more mobile terminals.

13. The method of claim 9 wherein connecting said call to at least one mobile terminal sharing said common number comprises establishing a group call involving two or more mobile terminals.

14. The method of claim 7 further comprising:
maintaining a subscriber database accessible to said switching center for storing said common number shared by two or more mobile terminals, wherein said switching center accesses said subscriber database to identify said mobile terminals.

15. A method of providing multi-extension functionality to a group of mobile terminals in a wireless communication network, comprising:
storing subscriber phone numbers in a subscriber database, said subscriber database including data indicating whether a subscriber phone number is a common number shared by two or more mobile terminals;
determining whether a called number associated with a call is a common number shared by two or more mobile terminals; and
connecting calls directed to a common number to at least one mobile terminal associated with the common number.

16. The method of claim 15 wherein connecting calls directed to a common number to at least one mobile terminal associated with the common number comprises:
selecting one or more mobile terminals sharing said common number; and
connecting said call to said selected mobile terminals.

17. The method of claim 16 wherein selecting one or more mobile terminals sharing said common number comprises:
prompting a caller to select at least one mobile terminal sharing said common number;
receiving the caller's selection; and
connecting said call to the mobile terminal selected by the caller.

18. The method of claim 17 further comprising establishing a group call if the caller selects two or more mobile terminals.

19. The method of claim 15 wherein connecting calls directed to a common number to at least one mobile terminal associated with the common number comprises establishing a group call involving two or more mobile terminals.

20. The method of claim 15 further comprising:
maintaining a subscriber database for storing said common number shared by two or more mobile terminals; and
accessing said subscriber database to identify said mobile terminals.

21. A method of providing multi-extension functionality to a group of mobile terminals in a wireless communication network, comprising:
assigning a common number to a group of two or more mobile terminals;
routing calls directed to said common number to at least one of said group of mobile terminals.

22. The method of claim 21 wherein routing calls directed to said common number to at least one of said group of mobile terminals comprises routing said calls to all said mobile terminals in said group.

23. The method of claim 22 wherein only the first said mobile terminal to answer said call is connected to the caller.

24. The method of claim 22 wherein all said mobile terminals that answer said call are connected to the caller.

25. The method of claim 21 wherein routing calls directed to said common number to at least one of said group of mobile terminals comprises routing said calls to one or more of said group of mobile terminals in response to a selection by the caller.

26. The method of claim 25 wherein the caller is provided a list of mobile terminals in said group and is prompted to select one or more of said mobile terminals.

27. The method of claim 26 wherein the caller is provided the option to select the first of said mobile terminals to answer said call.

28. The method of claim 26 wherein the caller is provided the option to select all of said mobile terminals.

29. The method of claim 21 further comprising storing in said at least one subscriber database, data indicating whether said common number is associated with a group of mobile terminals.

30. The method of claim 21 wherein said subscriber database includes a unique identifier associated with mobile terminal, and further comprising storing in said subscriber database, data indicating the last known position of said respective mobile terminal.

31. A method of placing a call from any of a group of mobile terminals, in a wireless communication network capable of reporting the telephone number of the originating mobile terminal, comprising:
assigning a common number to a group of two or more mobile terminals, each said mobile terminal associated with a telephone number;
when a mobile terminal in said group with an individual telephone number originates a call, reporting said common number in lieu of the individual telephone number of the originating mobile terminal.

32. The method of claim 31 wherein reporting said common number in lieu of the individual telephone number associated with said mobile terminal comprises blocking the reporting of the telephone number of the originating mobile terminal if said communication network is incapable of reporting said common number.

33. The method of claim 31 wherein reporting said common number in lieu of the individual telephone number associated with said mobile terminal comprises reporting said common number in response to the number called.

34. The method of claim 33 wherein said common number is not reported in lieu of said telephone number if said number called is associated with a mobile terminal within said group.

35. The method of claim 33 further comprising storing a list of at least one trusted telephone number associated with said telephone number in said at least one subscriber database, and wherein said common number is not reported in lieu of said telephone number if said number called is included in said list of trusted telephone numbers.

36. A wireless communication network, comprising:
a database storing subscriber information, said database storing at least one common number associated with a group of mobile terminals; and
a mobile switching center operative to route calls to one of said mobile terminals in said group when a call is placed by a party to said common number.

37. The network of claim 36 wherein said mobile switching center pages all available mobile terminals in said group, and routes said call to the first mobile terminal in said group to answer.

38. The network of claim 36 wherein said mobile switching center calls all available mobile terminals in said group, and routes said call to all mobile terminals in said group to answer, forming a conference call.

39. The network of claim 36 wherein said mobile switching center prompts said party to select a mobile terminal from said group, and routes said call to the selected mobile terminal.

40. A subscriber database for a wireless communication network, comprising:
a subscriber profile table for storing subscriber phone numbers and associating each subscriber phone number with at least one mobile terminal;
said subscriber profile table including data indicating whether a subscriber phone number is a common number shared by two or more mobile terminals.

41. The database of claim 40 further comprising data identifying the mobile terminals in said group.

42. The database of claim 40 further comprising data indicating the last known position of a mobile terminal in said group.

43. The database of claim 40 further comprising data relating to the putative user of a mobile terminal in said group.

44. The database of claim 40 further comprising data associated with said common number, said data indicating the order in which mobile terminals in said group should be called.
